(19) United States
(12) Patent Application Publication
(10) Pub. No.: US 2009/0024295 A1
(43) Pub. Date: Jan. 22, 2009

(54) SYSTEM AND METHOD FOR REMOTELY MONITORING A TURBOCHARGED ENGINE

(76) Inventors: Kendall Roger Swenson, Erie, PA (US); James Robert Mischler, Girard, PA (US); Luke Michael Henry, Erie, PA (US)

Correspondence Address: Dickinson Wright PLLC, 38525 Woodward Avenue, Suite 2000, Bloomfield Hills, MI, 48304, US

(21) Appl. No.: 11/778,737

(22) Filed: Jul. 17, 2007

(51) Int. Cl. G06F 19/00; G01M 15/00; G01F 1/38

(52) U.S. Cl. 701/100; 340/286.01; 73/861.47

(57) ABSTRACT

A method and system for remotely monitoring the operation of a multicylinder, turbocharged reciprocating engine includes monitoring one or more operating parameters predictive of the turbocharger's output, and generating a parametric output signal corresponding to the value of the sampled operating parameter. The parametric output signal is transmitted via telemetry to a remote diagnostic center, where actual mass flow is determined with a flow detection system, and then the charge air mass flow is compared with a predetermined flow rate corresponding to the monitored operating parameter, such as turbocharger speed or turbocharger pressure ratio. A condition flag is set if the actual charge air flow rate is less than a predetermined flow rate based upon the parametric output signal.

### BACKGROUND OF THE INVENTION

1. Field of the Invention

The present invention is related to a system for remotely monitoring the performance of a turbocharged reciprocating internal combustion engine.

2. Disclosure Information

Reciprocating internal combustion engines, such as diesel and spark-ignited engines frequently utilize turbocharging. In essence, most turbochargers are configured as a single shaft gas turbine engine having a compressor and turbine wheel attached for rotation on a common shaft. Because the turbine and, particularly the compressor, are aerodynamic devices using airfoil sections, turbochargers are subject to certain operational difficulties inherent to aero machinery, such as compressor surge or stall. Compressor surge is a condition characterized by separation of flow from certain of the compressors rotating and static surfaces. Severe surge may cause high frequency, oscillating airflow, resulting in large unbalanced forces which may quickly damage the turbocharger and the engine to which it is attached. Accordingly, engines have been monitored to detect operation tending toward surge. When operation tending toward surge is detected, the engine may be derated, causing a loss of horsepower output.

Turbocharged engines typically have extensive air piping extending from the turbocharger to the engine cylinders. Such piping has many joints and potential leak paths, particularly where an intercooler is employed in the air piping system. Unfortunately, leaks in the air piping system or intercooler may create the appearance of a compressor surge, because of a decrease in the engine's inlet manifold pressure, when no surge is present. This in turn may be the cause of unneeded derating of the engine, again when there is no surge problem. On the other hand, air piping, including intercoolers, may also be subject to plugging, and this may cause compressor surge.

Problems related to air handling leaks or air system plugging may be exacerbated in the case of engines which are operated at isolated sites, such as pipeline compressor stations, remotely sited generators, and even unmanned railroad locomotives positioned within large consists. Marine engines, too, are frequently operated well beyond the reach of normal support systems.

It would be desirable to have the capability remotely detect and report leaks or plugging in charge air piping extending between a turbocharger and the engine's cylinders, so as to avoid spurious compressor surge determinations, unneeded deration, and engine damage.

### SUMMARY OF THE INVENTION

According to an aspect of the present invention, a system for remotely monitoring operation of a multicylinder turbocharged reciprocating engine includes a speed detection system for determining the rotational speed of the turbocharger and a mass flow detection system for determining the actual flow rate of charge air to the engine cylinders. A controller, which is operatively connected with the speed detection system and the flow detection system, compares the actual charge air flow rate with a predetermined flow rate corresponding to the turbocharger's rotational speed. The predetermined flow rate is determined based upon a trend analysis of the rotational speeds and corresponding mass flow rates of a population of same-design engines, with the controller setting a condition flag if the actual charge air flow rate is less than the predetermined flow rate by a specific margin or threshold.

According to another aspect of the present invention, a controller embedded in the system may be located remotely from the engine, with said controller receiving said speed signal and said airflow signal through telemetry. Alternatively, the controller may be located proximate the engine, with the controller transmitting the condition flag by telemetry to a remotely located diagnostic center. As used herein, the term “telemetry” means the transmission of data by either a wireline, or by a satellite system, or by radio, or cell phone, or by other such systems known to those skilled in the art and suggested by this disclosure.

According to another aspect of the present invention, the population of same-design engines from which the trend analysis is drawn includes a population of engines having turbocharger and air induction system design characteristics which are generally equivalent to the turbocharger and air induction system design characteristics of the engine being monitored, and with the population of engines having actual air charge flow rates which are generally congruent with the predetermined flow rates. In other words, the population of engines used to establish a trend analysis is a population of engines without charge air leaks or plugging of the charge air handling system.

According to another aspect of the present invention, trend analysis may be performed by a regression analysis or other analytical technique, with the results of the regression analysis being stored within a memory contained within the controller, either in tabular form, or as an analytical expression. Alternatively, a trend analysis may be performed by using real-time regression on a single engine being monitored, so that the system controller ‘learns’ its own curve and does not rely on data from other engines. This assumes that the engine does not have either an early life air leak or a plugging problem, which is a generally a valid assumption, given a reasonable level of manufacturing quality control.

According to another aspect of the present invention, a method for monitoring operation of a multicylinder turbocharged reciprocating engine includes determining the rotational speed of the turbocharger with a speed detection system, and determining the actual flow rate of charge air through the engine cylinders, with a flow detection system. Then, the method further includes comparing the actual charge air flow rate with a predetermined flow rate corresponding to the turbocharger's rotational speed, with an onboard controller operatively connected with the speed detection system and the flow detection system. As described above, a predetermined flow rate is preferably based upon a trend analysis stored within the controller, of turbocharger rotational speeds and corresponding mass flow rates of a population of same-design engines without charge air leaks or plugging.

The method further includes setting a charge air condition flag indicating that a charge air leak or plugging exists downstream of the turbocharger if the actual charge air flow rate is less than a predetermined flow rate.

According to another aspect of the present invention, the method may also include derating the power output of the engine if the charge air condition flag is set. Finally, the present method may further include notifying the engine's operator if the charge air condition flag is set.

According to another aspect of the present invention, in a broader sense, the invention includes monitoring at least one operating parameter predictive of the turbocharger's output, and generating a parametric output signal corresponding to the value of at least one operating parameter. Then, after determining the actual mass flow rate of charge air to the engine cylinders, the method includes comparing the actual charge air flow rate with a predetermined flow rate corresponding to the monitored operating parameter, using a controller which receives a parametric output signal and the results from the flow detection system.

It is an advantage of a method and system according to the present invention that false positive detections of compressor surge may be avoided.

It is yet another advantage of a method and system according to the present invention that potentially dangerous leaks of high pressure, extremely hot, compressed air being discharged from a turbocharger compressor may be diagnosed in a timely fashion, so as to permit repairs to be made before engine performance is compromised.

It is yet another advantage of a method and system according to the present invention that unneeded horsepower derations and even failures of engines may be avoided, along with the extra costs associated with spurious determinations of compressor surge.

It is yet another advantage of a method and system according to the present invention that leaks and plugging in the air piping extending from a turbocharger to an engine's cylinders may be detected well before any noticeable degradation in engine performance occurs.

It is yet another advantage of a method and system according to the present invention that high pressure air leaks or plugging in a turbocharged engine may be communicated remotely, through either a wireline, or satellite or radio links, or through a cell phone link.

Other advantages, as well as features of the present invention, will become apparent to the reader of this specification.

### BRIEF DESCRIPTION OF THE DRAWINGS

FIG. 1 is a frontal elevation of an engine having a turbocharger and control system according to one aspect of the present invention.

FIG. 2 is a cutaway perspective view of a turbocharger suitable for use with an engine according to an aspect of the present invention.

FIGS. 3A and 3B are block diagrams of an engine and remote monitoring system according to an aspect of the present invention.

FIG. 4 is a flow diagram showing a method according to an aspect of the present invention.

FIG. 5 illustrates a flow plot according to an aspect of the present invention.

### DETAILED DESCRIPTION OF THE PREFERRED EMBODIMENTS

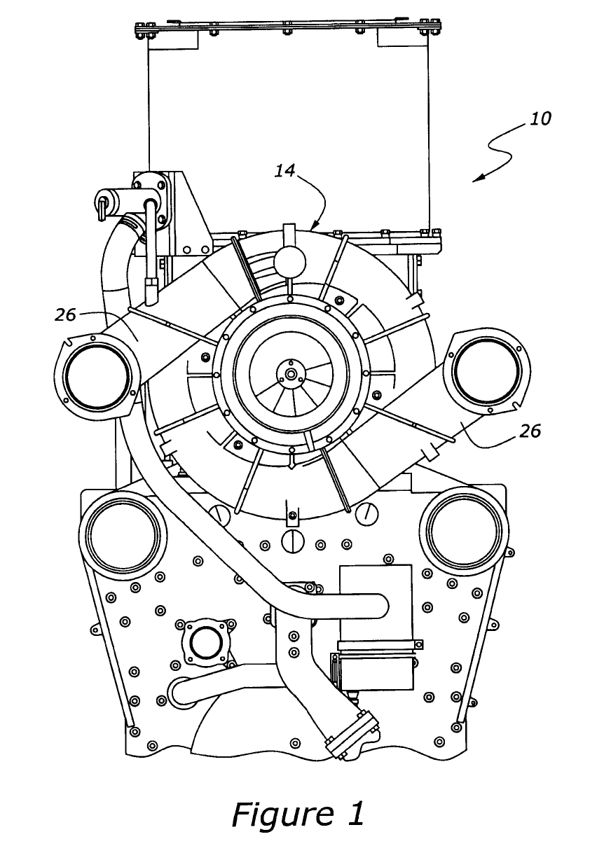

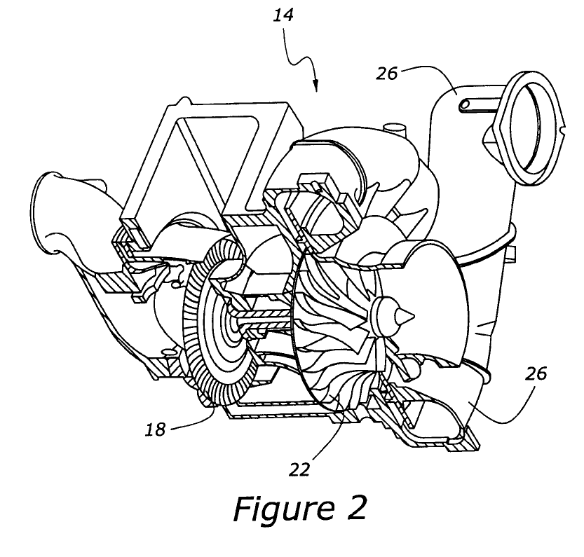

As shown in FIG. 1, engine 10 has a turbocharger, 14, installed. Engine 10 may be configured as either a diesel engine, or other type of compression ignition engine, or as a spark ignition engine, or yet other types of reciprocating internal combustion engines known to those skilled in the art and suggested by this disclosure. FIG. 2 shows that turbocharger 14 has an exhaust driven turbine 18, on a common shaft with a compressor, 22. Compressor 22 discharges air through outlet pipes 26, which are also shown in FIG. 1. From pipes 26, compressed charge air flows either directly to the cylinders of engine 10, or through an intercooler such as an air-to-air or air-to-liquid intercooler. What is important is that the air flowing from turbocharger 14 has many opportunities to leak from various joints in the air piping system extending between turbocharger 14 and the balance of engine 10. Moreover, an intercooler, if used, may become plugged or restricted for a variety of reasons, including deposit build up, or due to corrosion. And, mechanical damage to the charge air system piping may occur.

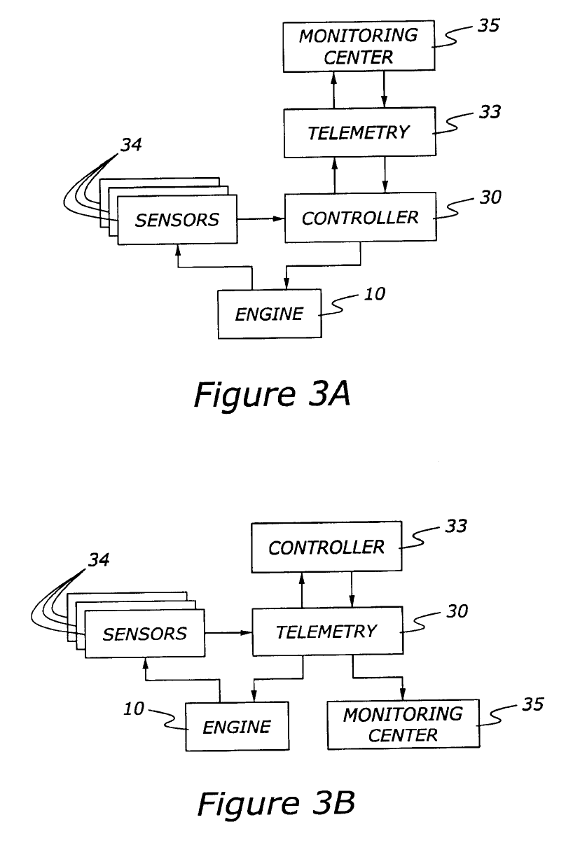

As shown in FIG. 3A, engine 10 has a number of sensors, 34, operationally connected with the engine. Sensors 34 measure such engine operating parameters as turbocharger speed, intake manifold pressure, charge air temperature, engine speed, and other operating parameters known to those skilled in the art and suggested by this disclosure. Sensors 34 provide parametric output signals to controller 30, which may comprise either a microprocessor-controller of the type commonly used to operate internal combustion engines, or other types of digital and analog controllers known to those skilled in the art and suggested by this disclosure. Controller 30 may be located proximate engine 10 and is operatively connected with a telemetry system, 33, which allows results of the controller's activity to be communicated to remote monitoring center 35. In the embodiment of FIG. 3B, controller 30 is located remotely from engine 10, with telemetry system 33 linking data from sensors 34 to controller 30. Controller 30 may be sited within a remote monitoring center, 35.

As noted above, telemetry system 33 may be selected according to the particular operational characteristics of the engine being monitored. Accordingly, for stationary engines, a wireline system may be preferred. For engines traveling beyond cell phone or radio coverage, satellite communication is preferred.

According to an embodiment of the present invention, controller 30 receives a signal from a rotational speed sensor (one of sensors 34) associated with turbocharger 14. Such sensors are commonly used in internal combustion engines and are known to those skilled in the art. A mass flow detection system for engine 10 may include, for example, a sensor providing direct measurement of the flow either through a hot wire anemometer, or through a speed-density system using manifold pressure, engine speed, and charge air temperature. If a speed-density system is employed, engine a mass flow rate may be calculated with the following expression:

Mass Flow Rate=K*MAP*RPM/MAT

where: MAP=manifold absolute pressure;

RPM=engine speed;

MAT=charge air absolute temperature; and

K=a constant determined for a particular engine.

Mass flow rate may be corrected for inlet air temperature by multiplying the raw mass flow value by a correction factor as follows:

Correction Factor=sqrt(TIA/Ref_Temp)/(BAP/Ref_Pressure).

Where: TIA=turbo inlet absolute temperature; and

BAP=barometric pressure.

Similarly, turbocharger speed may be corrected for mach number by the formula:

Corrected Turbo Speed=sensed turbo speed/sqrt(TIA/Ref_Temp).

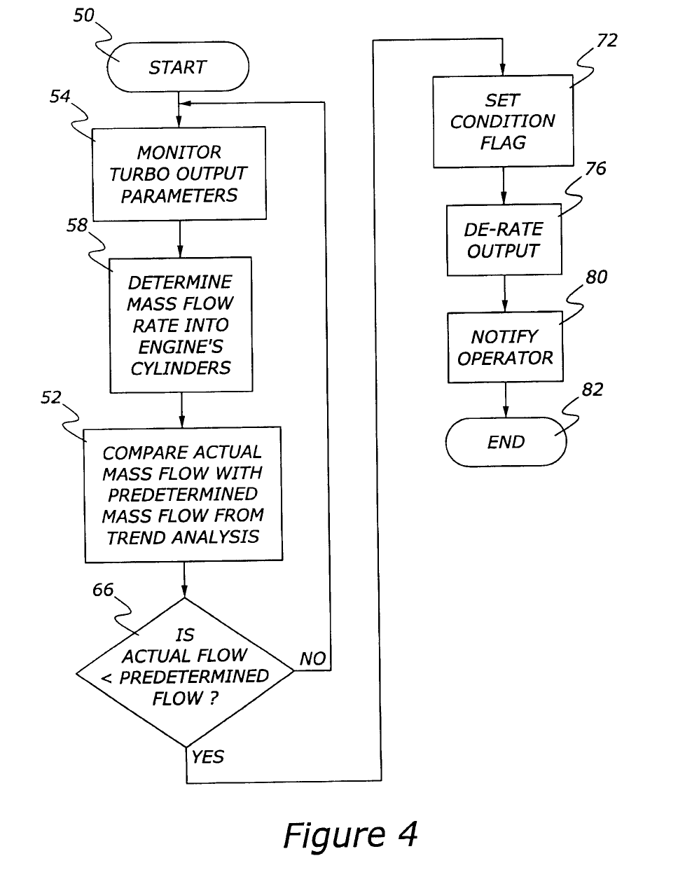

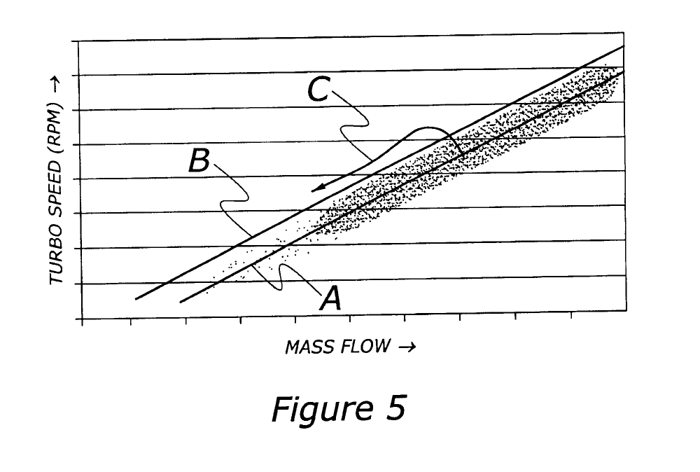

Having determined the mass flow and turbo speed of a particular engine, the process according to an aspect of the present invention may be continued according to the flow diagram of FIG. 4, which is depicted graphically in FIG. 5. FIG. 5 is a plot of turbo speed as a function of mass flow through the engine. A population of same-design engines, which are engines having turbocharger and air induction system design characteristics generally equivalent to the turbocharger and air induction system design characteristics of the engine being monitored is subjected to a trend analysis, which gives rise to curve A of FIG. 5. Curve A is determined through regression analysis of the complete universe of turbocharger rotational speeds and corresponding mass flow rates of the population of same-design engines which are known to be free of charge air leaks. In other words, the population of defect-free same-design engines has actual charge air flow rates which are generally congruent with the predetermined flow rates.

Curve A may be captured within controller 30 either as a lookup table or as an analytical expression. In either event, as engine 10 is monitored, and mass flow and turbo speed are determined, the process according to FIG. 4 is followed.

Beginning at block 50 of FIG. 4, controller 30 starts the monitoring process, and at block 54 controller 30 monitors turbo output parameters through one or more of sensors 34. This monitoring may include turbo speed, both raw and corrected, or turbocharger pressure ratio. Then, at block 58, controller 30 determines mass flow rate into the cylinders of engine 10, using either the previously described speed-density expression for mass flow, or by means of a suitably placed hot wire anemometer or other device, which will accurately detect flow into the engine's cylinders notwithstanding upstream leakage of air from defects in the air piping. Then, controller 30 moves to block 62 wherein the actual mass flow is compared with the predetermined mass flow from the trend analysis exhibited in FIG. 5. If the actual flow approximates the predetermined flow at block 66, then the routine continues with the monitoring at block 54. If, however, the actual flow is less than the predetermined flow at block 66 by a specific margin or threshold amount, controller 30 moves to block 72 wherein a condition flag is set indicating that there is a leak or obstruction in the air system between the turbocharger and the engine cylinders.

If the charge air leak or obstruction confirmed at block 66 is sufficiently severe that the engine's operation approaches curve B of FIG. 5, deration follows. Accordingly, at block 76, controller 30 derates output of engine 10 by changing the fueling, engine speed, or both. Then the engine's operator may be notified by remote monitoring center 35 of the air leak or plugging at block 80, before the routine is stopped at block 82. In the event of a deration, the path labeled “C” in FIG. 5 will be followed, wherein the operation of engine 10 is moved down the curve to a position of less mass flow, less turbo speed, and less output. Thus, it is seen that controller 30 monitors at least one operating parameter predictive of the output of turbocharger 14, with controller 30 receiving a parametric output signal from one or more sensors 34, while determining the mass flow through engine 10 by means of various parameters such as manifold absolute pressure, engine speed, and air charge temperature. Then, as described above, the actual charge air flow rate is compared with the predetermined flow rate, with a charge air condition flag being set if the actual charge air flow rate is less than the predetermined rate. Alternatively, the plot of FIG. 5 may be modified, to reflect a modification of the underlying process, by substituting compressor pressure ratio for mass flow.

According to another aspect of the present invention, the method of FIG. 4 may be modified by using turbocharger speed, instead of mass flow, as the operating parameter to be compared with a predicted value for the same parameter. Accordingly, measured turbocharger speed will be compared with the turbocharger speed normally corresponding to a sensed mass flow. If the actual turbo speed is greater than the predicted speed based upon the observed mass flow through the engine, the controller will set a condition flag. More generically, turbo speed may be predicted as a function of yet other operating parameters and compared with actual turbo speed to determine whether operation of the air supply system is compromised.

Although the present invention has been described in connection with particular embodiments thereof, it is to be understood that various modifications, alterations, and adaptations may be made by those skilled in the art without departing from the spirit and scope of the invention set forth in the following claims.

What is claimed is:

1. A system for remotely monitoring operation of a multicylinder, turbocharged reciprocating engine, comprising:
a speed detection system for determining the rotational speed of the turbocharger and for generating a speed signal corresponding to said rotational speed;
a mass flow detection system for determining the actual flow rate of charge air through the engine's cylinders and for generating an airflow signal corresponding to said flow rate; and
a controller, operatively connected with said speed detection system and said flow detection system, for receiving said speed signal and said airflow signal, with said controller comparing the actual charge air flow rate with a predetermined flow rate corresponding to the turbocharger's rotational speed, wherein said predetermined flow rate is based upon an analysis of the rotational speeds and corresponding mass flow rates of a population of same-design engines, with said controller setting a charge air condition flag if the actual charge air flow rate is less than the predetermined flow rate.

2. A monitoring system according to claim 1, wherein said population of same-design engines comprises a population of engines having turbocharger and air induction system design characteristics which are generally equivalent to the turbocharger and air induction system design characteristics of the engine being monitored, and with said population of engines having actual charge air flow rates which are generally congruent with said predetermined flow rates.

3. A monitoring system according to claim 1, wherein said engine comprises a diesel engine.

4. A monitoring system according to claim 1, wherein said engine comprises a spark-ignited engine

5. A monitoring system according to claim 1, wherein said charge air condition flag indicates that an air leak or obstruction exists in the engine's air intake system downstream of said turbocharger.

6. A monitoring system according to claim 1, wherein said controller is located remotely from said engine, with said controller receiving said speed signal and said airflow signal through telemetry.

7. A monitoring system according to claim 6, wherein said engine is installed in a railroad locomotive, with said telemetry comprising a satellite system.

8. A monitoring system according to claim 6, wherein said engine is installed in a railroad locomotive, with said telemetry comprising a radio system.

9. A monitoring system according to claim 6, wherein said engine is installed in a railroad locomotive, with said telemetry comprising a cell phone system.

10. A monitoring system according to claim 1, wherein said controller is located proximate said engine, with said controller transmitting said charge air condition flag through telemetry to a remotely located diagnostic center.

11. A monitoring system according to claim 1, wherein said charge air condition flag is set if the actual charge air flow rate is less than the predetermined flow rate by a predefined margin.

12. A method for remotely monitoring operation of a multicylinder, turbocharged reciprocating engine, comprising:
determining the rotational speed of the turbocharger with a speed detection system generating a speed signal corresponding to said rotational speed;
determining the actual flow rate of charge air through the engine's cylinders with a flow detection system generating an airflow signal corresponding to said flow rate;
transmitting the speed signal and the airflow signal to a remote monitoring center via telemetry;
comparing the actual charge air flow rate with a predetermined flow rate corresponding to the turbocharger's rotational speed, with a controller receiving said speed signal and said airflow signal, wherein said predetermined flow rate is based upon a trend analysis, stored within said controller, of the rotational speeds and corresponding mass flow rates for said engine; and
setting a charge air condition flag indicating that a charge air leak or restriction exists downstream of the turbocharger if the actual charge air flow rate is less than the predetermined flow rate.

13. A method according to claim 12, wherein said population of same-design engines comprises a population of engines having turbocharger and air induction system design characteristics which are generally equivalent to the turbocharger and air induction system design characteristics of the engine being monitored.

14. A method according to claim 12, wherein said engine comprises a diesel engine.

15. A method according to claim 12, wherein said engine comprises a spark-ignited engine.

16. A method according to claim 12, further comprising derating the power output of said engine if the condition flag is set.

17. A method according to claim 12, further comprising advising the operator of said engine that the engine's air handling system requires repair if said condition flag is set.

18. A method for remotely monitoring the operation of a multicylinder, turbocharged reciprocating engine, comprising:
monitoring at least one operating parameter predictive of the turbocharger's output and generating a parametric output signal corresponding to the value of said at least one operating parameter;
determining the actual mass flow rate of charge air through the engine's cylinders with a flow detection system, and generating an airflow signal corresponding to said flow rate;
transmitting the parametric output signal and the airflow signal to a remote monitoring center via telemetry;
comparing the actual charge air flow rate with a predetermined flow rate corresponding to said monitored operating parameter at said remote monitoring center, with a controller receiving said parametric output signal and said airflow signal, wherein said predetermined flow rate is based upon a trend analysis, stored within said controller, of said operating parameter and corresponding mass flow rates for said engine; and
setting a condition flag if the actual charge air flow rate is less than the predetermined flow rate.

19. A method according to claim 18, wherein said at least one operating parameter comprises the turbocharger's compressor pressure ratio.

20. A method according to claim 18, wherein said at least one operating parameter comprises the turbocharger's rotational speed.

21. A method according to claim 18, further comprising notifying the operator of said engine that the engine's air handling system requires repair if said condition flag is set.

22. A method for remotely monitoring the operation of a multicylinder, turbocharged reciprocating engine, comprising:
monitoring at least one operating parameter predictive of the turbocharger's output and generating a parametric output signal corresponding to the value of said at least one operating parameter;
determining the actual turbocharger pressure ratio, and generating a pressure ratio signal corresponding to said pressure ratio;
transmitting the parametric output signal and the pressure ratio signal to a remote monitoring center via telemetry;
comparing the actual pressure ratio with a predetermined pressure ratio corresponding to said monitored operating parameter at said remote monitoring center, with a controller receiving said parametric output signal and said pressure ratio signal, wherein said predetermined pressure ratio is based upon a trend analysis, stored within said controller; and
setting a charge air condition flag if the actual pressure ratio is less than the predetermined pressure ratio, by a threshold amount.

23. A method according to claim 22, wherein said at least one operating parameter predictive of the turbocharger's output comprises turbocharger rotational speed.

24. A method for remotely monitoring the operation of a multicylinder, turbocharged reciprocating engine, comprising:
monitoring at least one operating parameter predictive of the turbocharger's output and generating a parametric output signal corresponding to the value of said at least one operating parameter;
determining the actual turbocharger speed, and generating a turbo speed signal corresponding to said actual turbocharger speed;
transmitting the parametric output signal and the turbo speed signal to a remote monitoring center via telemetry;
comparing the actual turbocharger speed with a predetermined turbocharger speed corresponding to said monitored operating parameter at said remote monitoring center, with a controller receiving said parametric output signal and said turbo speed signal, wherein said predetermined turbocharger speed is based upon a trend analysis, stored within said controller; and
setting a charge air condition flag if the actual turbocharger speed is less than the predetermined turbocharger speed, by a threshold amount.

25. A method according to claim 24, wherein said at least one operating parameter predictive of the turbocharger's output comprises the flow rate of charge air to the engine's cylinders.
